(19) United States
(12) Patent Application Publication
(10) Pub. No.: US 2015/0113655 A1
(43) Pub. Date: Apr. 23, 2015

(54) System, Method and Computer Program Product for Using Opinions Relating to Trustworthiness to Block or Allow Access

(71) Applicant: Frederick William Strahm, Hillsboro, OR (US)

(72) Inventor: Frederick William Strahm, Hillsboro, OR (US)

(21) Appl. No.: 14/580,067

(22) Filed: Dec. 22, 2014

Related U.S. Application Data
(63) Continuation of application No. 11/852,948, filed on Sep. 10, 2007.
Application No. 11/852,948 is a continuation of application No. 11/281,963, filed on Nov. 16, 2005.

(51) Int. Cl. G06F 21/57; H04L 29/06

(52) U.S. Cl. CPC G06F 21/577; H04L 63/20
USPC 726/25

(57) ABSTRACT

A system, method and computer program product are provided. After identifying a computer readable item, at least one opinion relating to the trustworthiness of the identified computer readable item is received, utilizing a network. Access to the computer readable item is then blocked or allowed, based on at least one opinion.

### RELATED APPLICATIONS

The present application is a continuation of application Ser. No. 11/281,963 filed on Nov. 16, 2005, which is incorporated herein by reference.

### FIELD OF THE INVENTION

The present invention relates to blocking and allowing access to various computer readable items, and more particularly to blocking and allowing such access based on different criteria.

### BACKGROUND

With the advent of general access computer networks, such as the Internet, people may now easily exchange application data between computer systems. Unfortunately, some people have taken advantage of such easy data exchange by developing various threats, such as viruses.

In various computing environments, these types of threats are reduced by presenting a user with a dialog box asking if they wish to allow or block a particular request to access various applications, network traffic, files, etc. To this end, such entities that are deemed a threat may be blocked. In the specific context of a policy manager (e.g. McAfee® ePolicy Orchestrator®, etc.), the user is presented with such a dialog box, and any resultant policy is then pushed to a server where an administrator may determine if the user's decision needs to be changed. For example, if the end user has decided to allow an access that is deemed a security risk, the administrator can push a rule to block the access.

Unfortunately, an average user is usually in no position to actually determine if an access should be allowed, and, in some cases, does not even have access to somebody in such a position. While policy managers, for example, attempt to resolve this problem by pushing the policies to the administrator, even administrators, at times, may not be fully aware of all of the individual security problems that may affect a particular network.

There is thus a need for overcoming these and/or other problems associated with the prior art.

### SUMMARY

A system, method and computer program product are provided. After identifying a computer readable item, at least one opinion relating to the trustworthiness of the identified computer readable item is received, utilizing a network. Access to the computer readable item is then blocked or allowed, based on at least one opinion.

### BRIEF DESCRIPTION OF THE DRAWINGS

FIG. 1 illustrates a network architecture, in accordance with one embodiment.

FIG. 2 shows a representative hardware environment that may be associated with the server computers and/or client computers of FIG. 1, in accordance with one embodiment.

FIG. 3 shows an architecture for using opinions relating to trustworthiness to block or allow access to a computer readable item, in accordance with one embodiment.

FIG. 4 shows a method for submitting opinions relating to the trustworthiness of a computer readable item, in accordance with one embodiment.

FIG. 5 shows a method for receiving opinions relating to the trustworthiness of a computer readable item, in accordance with one embodiment.

FIG. 6 shows a graphical user interface for receiving opinions relating to the trustworthiness of a computer readable item, in accordance with one embodiment.

### DETAILED DESCRIPTION

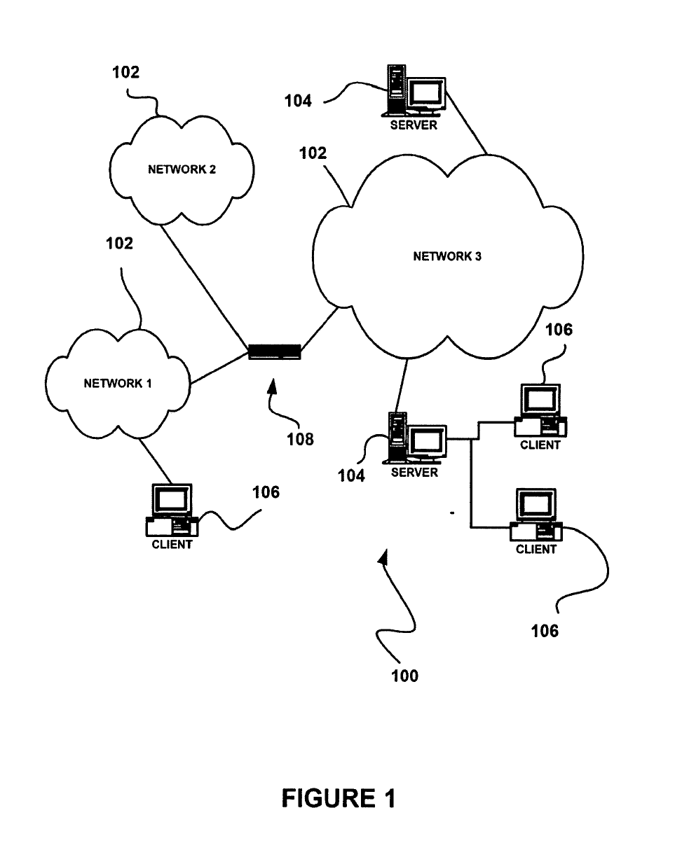

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, etc.

Coupled to the networks 102 are server computers 104 which are capable of communicating over the networks 102. Also coupled to the networks 102 and the server computers 104 is a plurality of client computers 106. Such server computers 104 and/or client computers 106 may each include a desktop computer, lap-top computer, hand-held computer, mobile phone, hand-held computer, peripheral (e.g. printer, etc.), any component of a computer, and/or any other type of logic. In order to facilitate communication among the networks 102, at least one gateway or router 108 is optionally coupled therebetween.

It should be noted that any of the foregoing network devices in the present network architecture 100, as well as any other unillustrated hardware and/or software, may be equipped with the capability of blocking and/or allowing access to various computer readable items. In the context of the present description, the term computer readable item may refer to an application program, network traffic, a file, and/or any entity capable of being accessed by a device.

In order to facilitate the decision as to whether to allow or block access to the computer readable item, such access may be blocked or allowed based on at least one opinion relating to the trustworthiness of the identified computer readable item. In the context of the present description, the term opinion may refer to any information received from a party or entity other than a party or entity which is allowing or blocking access to the computer readable item, based on such opinion.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

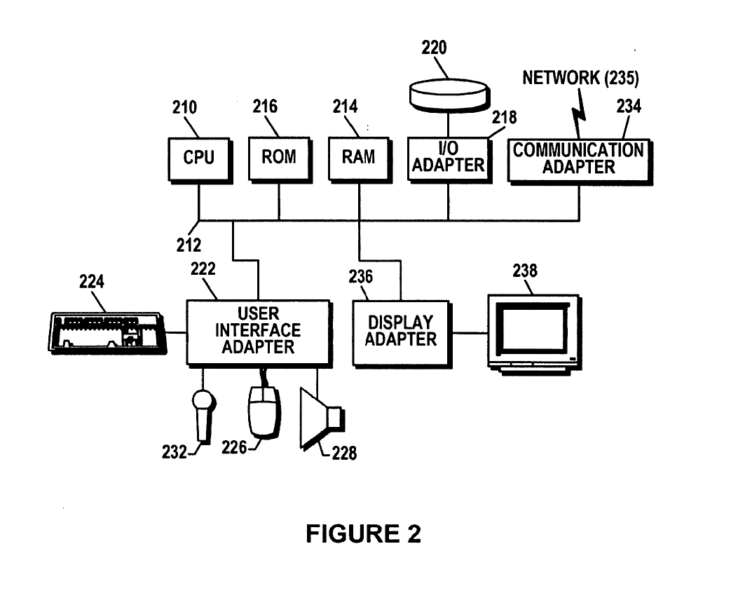

FIG. 2 shows a representative hardware environment that may be associated with the server computers 104 and/or client computers 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Our course, the various embodiments set forth herein may be implemented utilizing hardware, software, or any desired combination thereof. For that matter, any type of logic may be utilized which is capable of implementing the various functionality set forth herein.

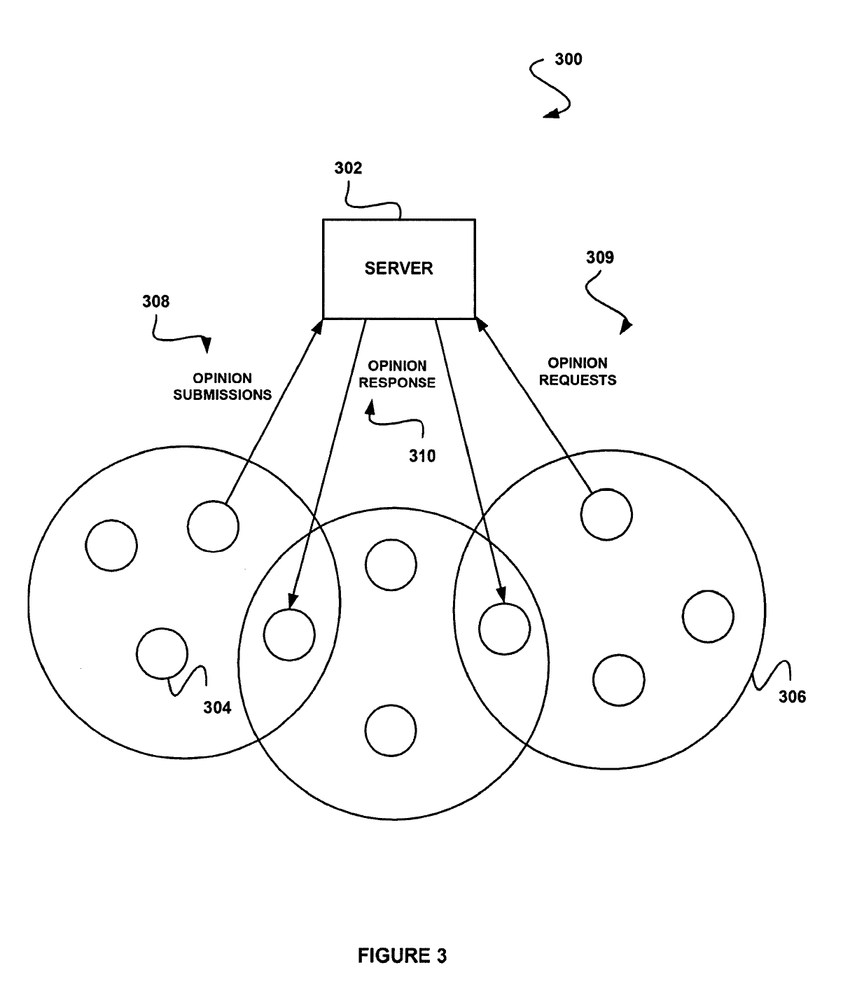

FIG. 3 shows an architecture 300 for using opinions relating to trustworthiness to block or allow access to a computer readable item, in accordance with one embodiment. As an option, the present architecture 300 may be implemented in the context of the architecture and environment of FIGS. 1 and/or 2. Of course, however, the architecture 300 may be carried out in any desired environment. Further, the definitions discussed hereinabove apply in the context of the present description.

As shown, a server 302 (e.g. see, for example, the server computers 104 of FIG. 1, etc.) is provided which is adapted to communicate with a plurality of users 304 associated with one or more corresponding clients (e.g. see, for example, the client computers 106 of FIG. 1, etc.) via one or more unillustrated networks (e.g. see, for example, the networks 102 of FIG. 1, etc.). Of course, while a single server 302 is shown in FIG. 3, it should be noted that a distributed environment is contemplated involving multiple computers, which are not necessarily server computers.

For reasons that will soon become apparent, the users 304 may be correlated into groups 306 based on various group criteria. Such group criteria may include, but is not limited to a status among the corresponding users 304 (e.g. friends, professional colleagues, organization member, etc.), a status of each associated user 304 (e.g. security expert, administrator, peer user, etc.), etc.

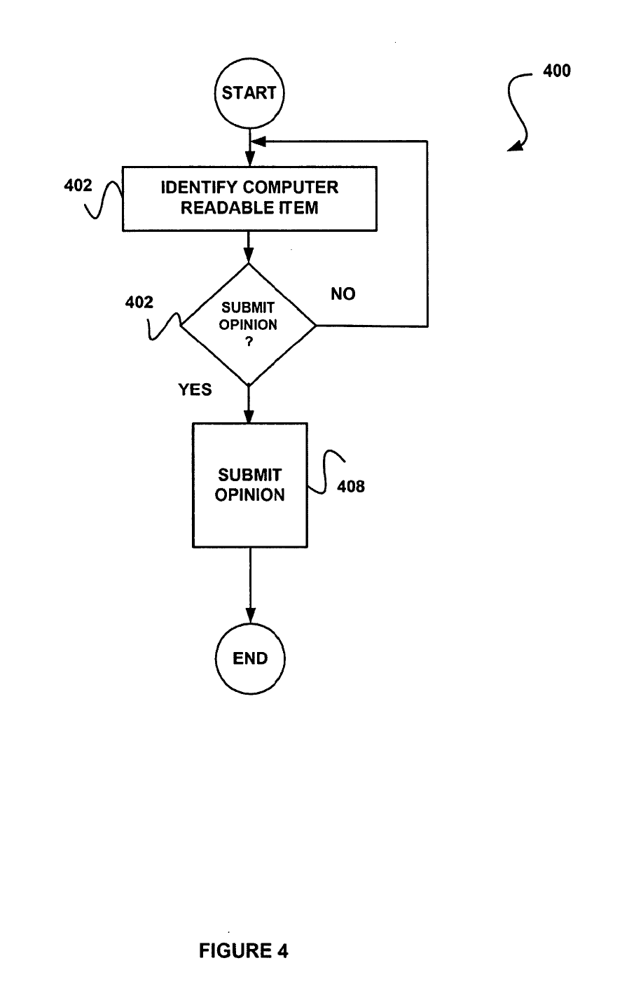

In use, the users 304 are capable of submitting opinions relating to the trustworthiness of various computer readable items to the server 302 via opinion submissions 308. The server 302, in turn, is adapted for storing such opinions in association with the computer readable item. More information relating to the opinion submission process will be set forth in greater detail during reference to FIG. 4.

As an option, for reasons that will soon become apparent, the server 302 may also be adapted for storing such opinions in association with the user 304 that submitted the opinion. In such embodiment, the aforementioned group criteria associated with the users 304 may also be stored and tracked. Of course, such group criteria may be updated based on a change in status, etc. either automatically or manually under the control of the user 304 or the server 302.

While the term criteria has thus far been used in the context of group criteria, it should be noted that additional criteria may also be stored in association with the opinions. Such additional criteria may be unrelated to the users 304 and groups thereof, but may rather relate to the opinion itself. For example, in another embodiment, the criteria may relate to an urgency of the opinion (e.g. high, medium, low, etc.). Thus, the term criteria, in the context of the present description, may refer to absolutely any aspect associated with the opinions.

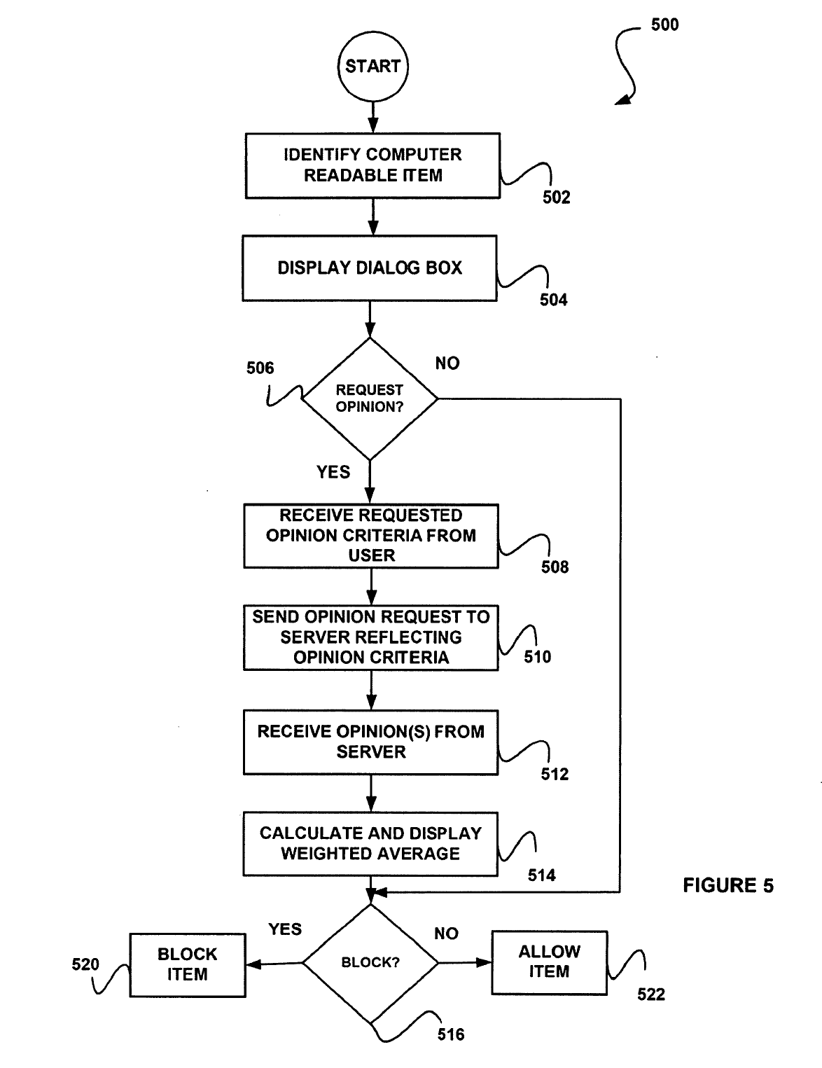

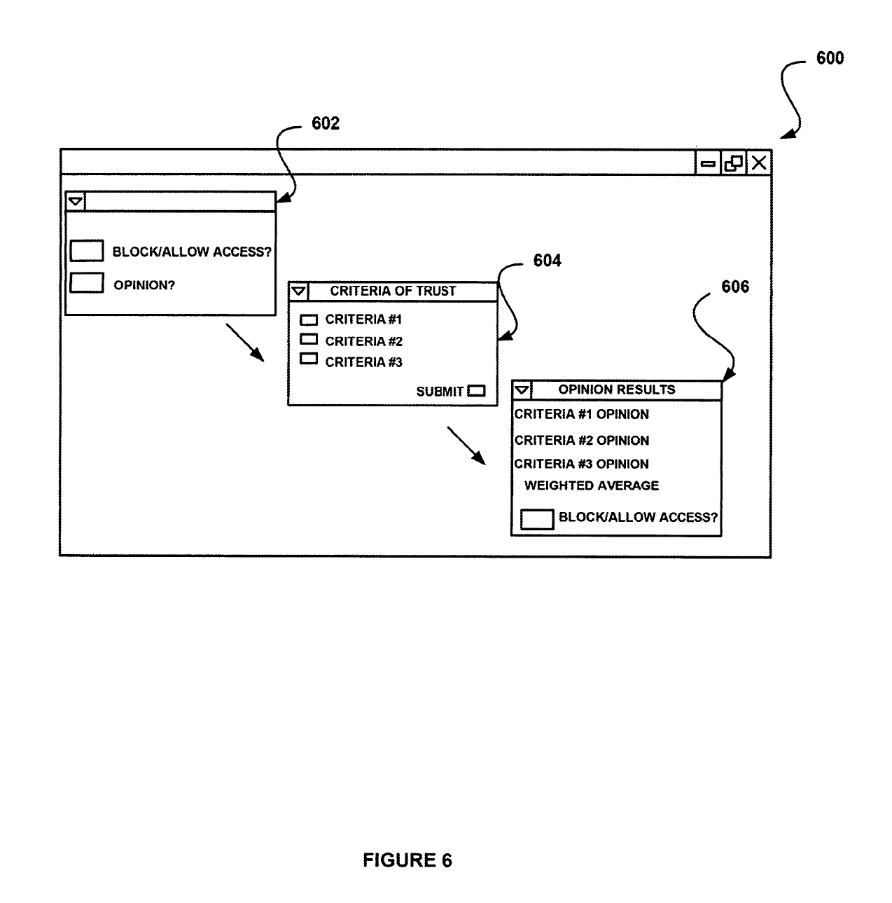

With such a database of opinions established at the server 302, the users 304 are capable of requesting such opinions from the sever 302 when such opinions are desired, utilizing opinion requests 309 via the network. This may, but does not necessarily, occur when the users 304 desire access to the computer readable item associated with the opinion. In response to such opinion requests 309, the server 302 transmits at least one opinion via an opinion response 310. More information relating to the opinion responses 310 will be set forth in greater detail during reference to FIGS. 5-6.

In an optional embodiment that employs the aforementioned criteria, the users 304 may include the criteria with the appropriate opinion request 309. To this end, the opinion sent via the opinion response 310 may further be tailored to include only those opinions that meet such criteria. More information regarding various exemplary ways such opinion response 310 may be tailored will be set forth in greater detail during reference to subsequent figures. In any case, armed with the appropriate opinions, the user (and/or the client operated by the user) is capable of more intelligently deciding whether to block or allow access to the associated computer readable item.

FIG. 4 shows a method 400 for submitting opinions relating to the trustworthiness of a computer readable item, in accordance with one embodiment. As an option, the present method 400 may be implemented in the context of the architecture and environment of FIGS. 1 and/or 2, and optionally in the specific context of the users 304 of FIG. 3. Of course, however, the method 400 may be carried out in any desired environment. Again, the definitions discussed hereinabove apply in the context of the present description.

As shown, a computer readable item is first identified in operation 402. It should be noted that such identification may be an automated or manual, and passive or active operation. Just by way of example, the computer readable item may be identified when it is determined that access thereto is desired by a user (e.g. see, for example, the user 304 of FIG. 3, etc.). Of course, this may be initiated upon a user attempting to access the computer readable item.

In another embodiment, for example, the computer readable item may be identified by a scanner, firewall, etc. that monitors various computer readable items that meet various parameters (e.g. computer readable items that attempt to access a client of a user, computer readable items that are operating suspiciously, etc.). To this end, the computer readable items may be identified in any desired manner that prompts at least a potential need for an opinion relating to the trustworthiness of such computer readable item.

Upon the computer readable item being identified, it is then determined whether an opinion is to be submitted. See decision 402. Again, this may be an automated or manual, and passive or active decision. For example, the decision may be affirmative for all identified computer readable items. On the other hand, this decision may be conditioned on input from the user on a computer readable item-by-computer readable item basis and/or conditioned based on user configured rules (e.g. always prompt an opinion submission upon the identification of certain computer readable items, etc.).

If it is determined in decision 402 that an opinion is to be submitted, an opinion is submitted in operation 408. Yet again, this may be an automated or manual, and passive or active operation. In one embodiment, such submission may involve input from the user, simply include any information relating to the manner in which the user and/or client reacted to the identified computer readable item, and/or any other opinion.

In one specific optional embodiment, the opinion may be received via a dialog box. Further, while the opinion may refer to any information received, such opinion may, in one embodiment, include a numerical value representative of a level of trustworthiness of a particular computer readable item. For example, a “1” may indicate a minimal level of trustworthiness while a “10” may indicate a maximum level of trustworthiness.

FIG. 5 shows a method 500 for receiving opinions relating to the trustworthiness of a computer readable item, in accordance with one embodiment. As an option, the present method 500 may be implemented in the context of the architecture and environment of FIGS. 1 and/or 2, and optionally in the specific context of the server 302 of FIG. 3. Of course, however, the method 500 may be carried out in any desired environment. Again, the definitions discussed hereinabove apply in the context of the present description.

As shown, a computer readable item is first identified in operation 502. It should be noted that the present identification may be carried out in a manner similar to operation 402 of FIG. 4. Thus, the description of operation 402 of FIG. 4 is incorporated herein. Of course, in a situation where the same user is both submitting and requesting an opinion, the submission may, in one embodiment, occur subsequent to a request of the opinion of others.

While the opinion may be requested/received in absolutely in any desired manner, it may, in one embodiment, be received via a dialog box. To this end, a dialog box may be displayed in operation 504. While such dialog box may take on any form, more information regarding various exemplary dialog boxes will be set forth during the description of FIG. 6.

Next, in decision 506, it is determined whether an opinion is requested. If not, the method 500 skips to decision 516 to simply allow a user (e.g. see, for example, the users 304 of FIG. 3, etc.) to either block or allow a computer readable item without an opinion regarding trustworthiness, as will be set forth later in greater detail. If, however, it is determined that an opinion is requested in decision 506, various opinion criteria (described during the description of FIG. 3) is received from the user. Note operation 508. Of course, this operation is strictly an option, as an embodiment is contemplated where no such criteria is utilized.

In operation 510, an opinion request is sent by the user to a server (e.g. see, for example, the server 302 of FIG. 3, etc.), along with the opinion criteria, if any. Using such information, the server is capable of sending, for receipt by the user, at least one opinion. Note operation 512.

As yet another option, multiple opinions may be received, such that a weighted average may be calculated in operation 514. Specifically, a weighted average may be calculated based on the plurality of opinions. For example, one opinion of a first peer may be deemed more relevant or important to the user with respect to another opinion of a second peer, based on criteria associated with such opinions (or based on anything else, for that matter). Thus, the more relevant or important opinion may be given more weight than others.

Table 1 illustrates an exemplary weighted average, where the opinions take the form of a numerical value (e.g. 1-10, etc.) in the exemplary embodiment set forth during the description in FIG. 4. Of course, such weighted average should not be construed as limiting in any manner whatsoever, as any weighted average may be utilized.

TABLE 1

Opinion #1 - most relevant
Opinion #2 - moderately relevant
Opinion #3 - less relevant
Opinion #4 - no relevance
Opinion #1 * (.6) + Opinion #2 * (.3) + Opinion #3 * (.1) +
Opinion #4 * (.00)

The foregoing weights may be predetermined or user configured to be a function of certain criteria associated with the opinions. Thus, a user may determine the extent to which each opinion provider (or any other criteria) is trusted. Still yet, criteria thresholds may optionally be utilized, such that opinions with criteria that do not meet a predetermined threshold are dismissed.

While, in the context of the above example, the weighted average is calculated at a computer of the user, it should be noted that such calculations may also be done at the server (or other computing entity), such that the weighted average (or similar calculation) is simply received by the user computer.

Thus, with the opinion of operation 514, a more intelligent decision may be made as to whether to block or allow access to a particular computer readable item. Specifically, based on such opinion, it may be determined whether the computer readable item is to be blocked in decision 516, such that the computer readable item may be blocked in operation 520 or allowed in operation 522.

Such blocking and allowing may be accomplished in any desired automated or manual, and passive or active manner. For example, in the context of the present embodiment, such decision 516 may be made based on input from a user via the aforementioned dialog box. More information will now be set forth regarding exemplary dialog boxes that may be used during the course of operations of FIG. 5.

FIG. 6 shows a graphical user interface 600 for receiving opinions relating to the trustworthiness of a computer readable item, in accordance with one embodiment. As an option, the present graphical user interface 600 may be implemented in the context of the architecture and environment of FIGS. 1-4, and optionally in the specific context of the method 500 of FIG. 5. Of course, however, the graphical user interface 600 may be implemented in any desired environment. Yet again, the definitions discussed hereinabove apply in the context of the present description.

As shown, a first window 602 is provided with a first icon for blocking or allowing the access to the computer readable item, which may be used during decision 516 of FIG. 5, for example. Still yet, as further shown, the first window 602 may further be equipped with a second icon for requesting an opinion, which may be used during decision 508 of FIG. 5, for example.

Also, a second window 604 is provided which may be displayed in response to the user selection of the second icon of the first window 602. Such second window 604 is adapted to receive any opinion criteria via a plurality of selectors (or any fields, for that matter), as set forth in operation 510 of FIG. 5, for example. Still yet, as further shown, the second window 604 may optionally be equipped with a submit icon for requesting the opinion, along with the criteria.

Still yet, a third window 606 is provided for displaying the opinion(s) (possibly including a weighted average), per operation 514 of FIG. 5, for example. Also, as shown, a block/allow icon is again displayed for blocking or allowing the access to the computer readable item, which may be used during decision 516 of FIG. 5, for example. Unlike the use of the correlating icon of the first window 602, the block/allow icon of the present window 606 may be used more intelligently based on the displayed opinion(s).

While the various windows are shown simultaneously on the graphical user interface 600, it should be noted that such windows may be also be displayed one-at-time, sequentially. Further, the various icons associated such windows may be arranged in different or same interfaces, as desired.

While various embodiments have been described above, it should be understood that they have been presented by way of example only, and not limitation. For example, any of the network elements may employ any of the desired functionality set forth hereinabove. Thus, the breadth and scope of a preferred embodiment should not be limited by any of the above-described exemplary embodiments, but should be defined only in accordance with the following claims and their equivalents.

1-19. (canceled)

20. At least one machine accessible storage medium having code stored thereon that, when executed on a machine, causes the machine to perform a method comprising:
receiving at least one opinion relating to a trustworthiness of an identified computer readable item, utilizing a network;
displaying the at least one opinion relating to the trustworthiness of the computer readable item, wherein the displaying displays a first visual indicator of a level of trustworthiness related to a security risk associated with allowing access to the computer readable item;
displaying a second visual indicator to allow the access to the computer readable item; and
allowing the access to the computer readable item based on a received input relating to the second visual indicator.

21. The medium of claim 20, wherein the computer readable item is an application program.

22. The medium of claim 20, wherein the computer readable item is a file.

23. The medium of claim 20, the method further comprising:
identifying the computer readable item via a scan.

24. The medium of claim 20, wherein the received input is a user input.

25. The medium of claim 20, the method further comprising:
displaying a third visual indicator to block the access to the computer readable item.

26. The medium of claim 20, wherein the received input is received via a dialog box.

27. The medium of claim 20, wherein the at least one opinion facilitates a decision as to whether to allow the access to the computer readable item.

28. The medium of claim 20, the method further comprising:
requesting the at least one opinion upon an attempt to access the computer readable item.

29. A method, comprising:
receiving at least one opinion relating to a trustworthiness of an identified computer readable item, utilizing a network;
displaying the at least one opinion relating to the trustworthiness of the computer readable item, wherein the displaying displays a first visual indicator of a level of trustworthiness related to a security risk associated with allowing access to the computer readable item;
displaying a second visual indicator to allow the access to the computer readable item; and
allowing the access to the computer readable item based on a received input relating to the second visual indicator.

30. The method of claim 29, wherein the computer readable item is an application program.

31. The method of claim 29, further comprising:
displaying a third visual indicator to block the access to the computer readable item.

32. The method of claim 29, wherein the received input is received via a dialog box.

33. The method of claim 29, further comprising:
requesting the at least one opinion upon an attempt to access the computer readable item.

34. An apparatus, comprising:
a communication adapter that receives at least one opinion relating to a trustworthiness of an identified computer readable item, utilizing a network;
a display adapter that causes a display of the at least one opinion relating to the trustworthiness of the computer readable item, wherein the display of the at least one opinion includes a first visual indicator of a level of trustworthiness related to a security risk associated with allowing access to the computer readable item, and the display adapter causes a display of a second visual indicator to allow the access to the computer readable item; and
a processor configured to allow the access to the computer readable item based on a received input relating to the second visual indicator.

35. The apparatus of claim 34, wherein the computer readable item is an application program.

36. The apparatus of claim 34, wherein the display adapter causes a display of a third visual indicator to block the access to the computer readable item.

37. The apparatus of claim 34, wherein the received input is received via a dialog box.

38. The apparatus of claim 34, wherein the at least one opinion facilitates a decision as to whether to allow the access to the computer readable item.

39. The apparatus of claim 34, wherein the communication adapter requests the at least one opinion upon an attempt to access the computer readable item.
